(19) United States
(12) Patent Application Publication
(10) Pub. No.: US 2014/0376420 A1
(43) Pub. Date: Dec. 25, 2014

(54) COMMUNICATIONS APPARATUS USING TRAINING SIGNAL INJECTED TO TRANSMISSION PATH FOR TRANSMISSION NOISE SUPPRESSION/CANCELLATION AND RELATED METHOD THEREOF

(71) Applicant: MediaTek Singapore Pte. Ltd., Singapore (SG)

(72) Inventors: Qiang Zhou, San Jose, CA (US); Balachander Narasimhan, Milpitas, CA (US); Charles Chien, Newbury Park, CA (US); Jonathan Richard STRANGE, Reigate (GB); Paul Cheng Po Liang, Hsinchu County (TW)

(73) Assignee: MediaTek Singapore Pte. Ltd., Singapore (SG)

(21) Appl. No.: 14/133,651

(22) Filed: Dec. 19, 2013

Related U.S. Application Data
(60) Provisional application No. 61/836,842, filed on Jun. 19, 2013.

(51) Int. Cl. H04L 5/14

(52) U.S. Cl. CPC H04L 5/1461
USPC 370/278

(57) ABSTRACT

A communications apparatus has a transmitter path and a training signal generator. The transmitter path is arranged for transmitting a transmission signal. The training signal generator is arranged for generating a training signal in a receiver band, and injecting the training signal to the transmitter path. The training signal is utilized to obtain an accurate estimation of the channel which helps to suppress transmission noise comprised in at least one received signal of the communications apparatus, and the transmission noise is generated by the transmitter path. Specifically, the communications apparatus further has a receiver path and a transmission noise suppression device. The receiver path is arranged for receiving a received signal. The transmission noise suppression device is arranged for receiving the training signal, and processing the received signal to suppress transmission noise comprised in the received signal according to at least the training signal.

### CROSS REFERENCE TO RELATED APPLICATIONS

This application claims the benefit of U.S. provisional application No. 61/836,842, filed on Jun. 19, 2013 and incorporated herein by reference.

### BACKGROUND

The disclosed embodiments of the present invention relate to transmission noise suppression/cancellation, and more particularly, to a communications apparatus using training signal injected into a transmission path for transmission noise suppression/cancellation and related method thereof.

With advancements in communications techniques, mobile stations (MS, which may be interchangeably referred to as user equipment (UE)) are now capable of handling multiple radio access technologies, such as at least two of GSM/GPRS/EDGE (Global System for Mobile Communications/General Packet Radio Service/Enhanced Data rates for Global Evolution), W-CDMA (Wideband Code Division Multiple Access), WiFi (Wireless Fidelity), LTE (Long Term Evolution), and the like. Generally, different radio access technologies operate in different frequency bands. However, some of them may still operate in a frequency band that is close to or even overlaps with the operating band of one or more other radio access technologies.

When considering the non-linearity of radio-frequency (RF) devices utilized in a radio module, high-order inter-modulation (IM) terms may be generated and occupy a wide range of frequency bands. For example, a power amplifier (PA) may generally generate the high-order IM terms for high output powers which extend outside of the desired transmission band as wideband noise. Therefore, when two radio modules having operating bands that are close to or overlap each other are integrated into one communications apparatus, mutual interference may occur when one is transmitting uplink signals and the other one is receiving downlink signals, since the transmitted uplink signals may leak to (that is, be captured by) the antenna of the receiving radio module. Those IM terms and wideband noise resulting from the PA are together called transmission (TX) skirts (or TX noise). The TX noise issue becomes worse when two radio modules are disposed very close to each other when integrated into one communications apparatus.

The TX noise causes severe desensitization of the receiver in the frequency-division duplexing (FDD) mode and in-device coexistence (IDC) scenario, and generally requires duplexers with high isolation. However, pure analog solutions using duplexers and SAW filters result in high insertion loss and potentially high cost. Typically, one duplexer is required per operating band. Thus, there is a need for a cost-effective and high-performance noise suppression/cancellation scheme.

### SUMMARY

In accordance with exemplary embodiments of the present invention, a communications apparatus using a training signal injected into a transmission path for transmission noise suppression/cancellation and related method thereof are proposed, to solve the above-mentioned problem.

According to a first aspect, an exemplary communications apparatus is disclosed. The exemplary communications apparatus includes a transmitter path and a training signal generator. The transmitter path is arranged for transmitting a transmission signal. The training signal generator is arranged for generating a training signal in a receiver band, and injecting the training signal to the transmitter path. The training signal is utilized to obtain an accurate estimation of the channel which helps to suppress transmission noise comprised in at least one received signal of the communications apparatus, and the transmission noise is generated by the transmitter path.

According to a second aspect of the present invention, an exemplary method applied in a communications apparatus is disclosed. The exemplary method includes at least the following steps: transmitting a transmission signal via a transmitter path; and generating a training signal in a receiver band, and injecting the training signal to the transmitter path. The training signal is utilized to obtain an accurate estimation of the channel which helps to suppress transmission noise comprised in at least one received signal of the communications apparatus, and the transmission noise is generated by the transmitter path.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of a communications apparatus according to an embodiment of the invention.

FIG. 2 shows a block diagram of a radio module according to an embodiment of the invention.

FIG. 3 is a diagram illustrating a training signal generator according to a first embodiment of the present invention.

FIG. 4 is a diagram illustrating a training signal generator according to a second embodiment of the present invention.

FIG. 5 is a diagram illustrating a portion of circuitry of a communication apparatus according to an embodiment of the present invention.

FIG. 6 is a diagram illustrating a transmission noise suppression device according to a first embodiment of the present invention.

FIG. 7 is a diagram illustrating a transmission noise suppression device according to a second embodiment of the present invention.

FIG. 8 is a diagram illustrating a first speed-up strategy according to an embodiment of the present invention.

FIG. 9 is a diagram illustrating a second speed-up strategy according to an embodiment of the present invention.

FIG. 10 is a diagram illustrating a transmission noise suppression device according to a third embodiment of the present invention.

FIG. 11 is a flowchart illustrating the adaptive mode switching scheme employed by the transmission noise suppression device in FIG. 10 according to an embodiment of the present invention.

FIG. 12 is a diagram illustrating a transmission noise suppression device according to a fourth embodiment of the present invention.

FIG. 13 is a diagram illustrating a transmission noise suppression device according to a fifth embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The concept of the present invention is to use a digitally assisted approach to suppress/cancel the TX skirt in a digital domain with an analog auxiliary/reference path which samples the TX skirt. More specifically, the present invention proposes a training-based transmission noise suppression/cancellation approach which injects a training signal in the receiver band to a transmitter path and extracts the training signal in the auxiliary/reference path that acts as a clear reference for estimating the channel between transmission and receiving paths. In addition to a desired TX noise reference in an auxiliary/reference path, an undesired TX noise copy generated due to non-linearity of the auxiliary/reference path as well as reciprocal mixing may also present in the auxiliary/reference path, which limits the accuracy of channel estimation of the adaptive filter and thus degrades the transmission noise suppression/cancellation performance. Injecting a training signal to create a clear reference can solve this issue. The training signal sees a channel identical to that viewed by the desired TX noise reference, and the training signal is un-correlated to the desired TX noise reference and its leaked copy in the main receiver path. Hence, a correct channel is estimated using the training signal. With the help of the correct channel, the TX noise in the main receiver path is suppressed/cancelled by the desired TX noise reference in the auxiliary/reference path. Besides, with regard to the proposed training-based approach, there is no frequency location limitation, the training signal can be extracted with high quality because only linear operations are involved, and the discontinuous transmission (DTX) is supported due to a non-stopping training signal generation. Further, the proposed training-based approach is suitable for systems on two chips because the training signal generation follows a fixed pattern and it only requires some proper alignment of trigger to achieve synchronization. Moreover, there may be crosstalk between the main receiver path and the auxiliary/reference path due to limited isolation. The crosstalk issue may be solved by a conventional linear decorrelation method, a conventional non-linear decorrelation method, or a conventional independent component analysis (ICA) method. However, the performance of decorrelation-based approaches degrades with the increment of the channel length, and the ICA performance is rather poor for convolutive channel. Compared to these conventional methods, the proposed training-based approach presents consistent performance regardless of the channel length. Further description of the proposed training-based approach is detailed as below.

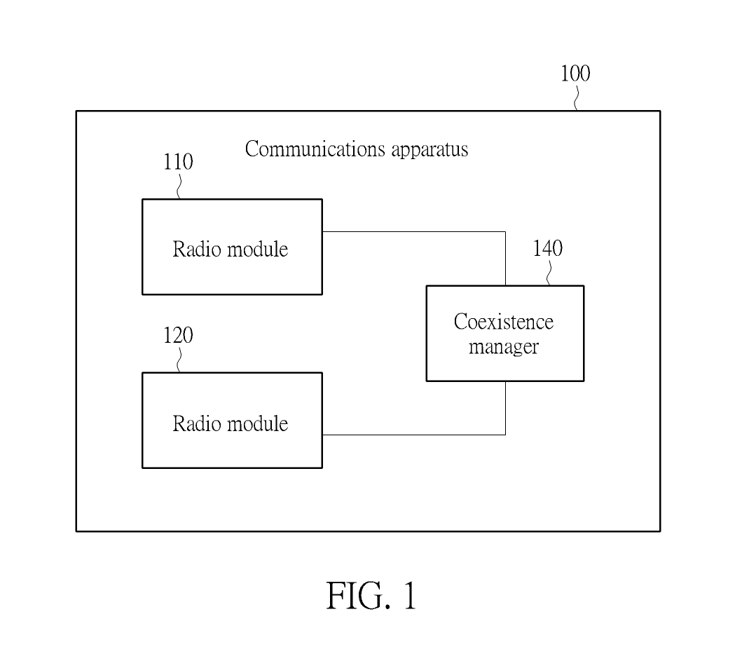

FIG. 1 shows a block diagram of a communications apparatus according to an embodiment of the invention. The communications apparatus 100 may include at least two radio modules 110 and 120 and a coexistence manager 140. The radio module 110 is arranged to provide a first wireless communications service and may communicate with a first peer communications apparatus (for example, a base station, an access point, or the like) in compliance with a first protocol. The radio module 120 is arranged to provide a second wireless communications service and may communicate with a second peer communications device (for example, abase station, an access point, or the like) in compliance with a second protocol. Each of the radio modules 110 and 120 includes at least one transmitter path (i.e., uplink path) for signal transmission and at least one receiver path (i.e., downlink path) for signal reception. The coexistence manager 140 is coupled to the radio modules 110 and 120, and is arranged to manage coordination between the transceiving operations of the radio modules 110 and 120.

Note that in some embodiments of the present invention, the communications apparatus 100 may have more than two radio modules. In yet other embodiments of the present invention, the coexistence manager 140 may be integrated in either of the radio modules 110 and 120. Therefore, the architecture as shown in FIG. 1 is merely an example, and the present invention should not be limited thereto. Note further that, in the embodiments of the present invention, the radio modules 110 and 120 may be implemented in different chips, or may be integrated into one chip, such as an SoC (system on chip).

In the embodiments of the present invention, the communications apparatus 100 may be a notebook computer, a cellular phone, a portable gaming device, a portable multimedia player, a tablet computer, a Global Positioning System (GPS) receiver, a Personal Digital Assistant (PDA), or others. In addition, in the embodiments of the present invention, the radio modules co-located in the communications apparatus may include a WiMAX module, a WiFi module, a Bluetooth module, a 2G/3G/4G or LTE module, a GSP module, or others, for providing the corresponding communications services in compliance with the corresponding protocols.

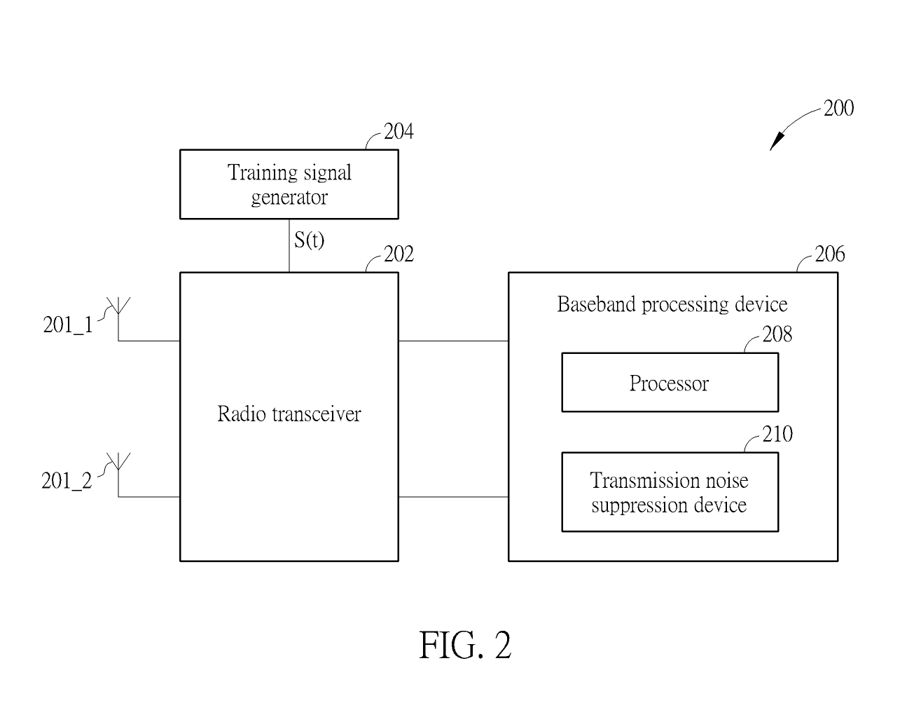

FIG. 2 shows a block diagram of a radio module according to an embodiment of the invention. The radio module 200 may include one or more antennas 201_1, 201_2, a radio transceiver 202, a training signal generator 204, and a baseband processing device 206. The radio module 200 may be used to implement one or both of the radio modules 110 and 120 as shown in FIG. 1. Note that although there are two antennas shown in FIG. 2, it should be understood that the radio module 200 may have only one antenna (e.g., a shared antenna) or more than two antennas.

The radio transceiver 202 may receive wireless radio frequency signals via one or more of the antennas 201_1, 201_2, convert the received signals to baseband signals to be processed by the baseband processing device 206, or receive baseband signals from the baseband processing device 206 and convert the received signals to wireless radio frequency signals to be transmitted to a peer communications apparatus. The radio transceiver 202 may include a plurality of hardware devices required to perform radio frequency conversion. For example, the radio transceiver 202 may include a mixer to multiply the baseband signals with a carrier oscillated in the radio frequency of the corresponding wireless communications system. The baseband processing device 206 may further convert the baseband signals to a plurality of digital signals and process the digital signals, and vice versa. The baseband processing device 206 may include a plurality of hardware devices to perform baseband signal processing, such as a processor 208, a transmission noise suppression device 210 (which will be further illustrated in the following paragraphs), and other circuitry (not shown). The baseband signal processing may include analog-to-digital conversion (ADC)/digital-to-analog conversion (DAC), gain adjustment, modulation/demodulation, encoding/decoding, etc.

Note that in some embodiments of the invention, the radio module 200 may further include another processor configured outside of the baseband processing device 206 for controlling operations of the baseband processing device 206 and the radio transceiver 202, and a memory device (not shown) which stores the system data and program codes. Therefore, the present invention should not be limited to the architecture as shown in FIG. 2. Note further that in some embodiments of the invention, there may be one or more transmission noise suppression devices implemented in the same communications apparatus (such as the communications apparatus 100). When there is only one transmission noise suppression device configured in the communications apparatus, the transmission noise suppression device may be integrated into the baseband processing device of one of the radio modules. On the other hand, when there are multiple transmission noise suppression devices configured in the communications apparatus, each transmission noise suppression device may be integrated in one radio module.

In this embodiment, the training signal generator 204 is arranged to generate a training signal S(t) at an RX band of an un-intended receiver when the transmitter of the radio transceiver 202 is an interfering transmitter, where the interfering transmitter and the un-intended receiver are usually referred to as the aggressor and the victim, respectively. The training signal generator 204 injects the training signal S(t) to a transmitter path where the interfering transmitter is located. The training signal S(t) is utilized to aid channel estimation for the adaptive filter to suppress transmission noise comprised in at least one received signal of the communications apparatus (e.g., communications apparatus 100), where the transmission noise is generated by the operating transmitter path where the interfering transmitter is located.

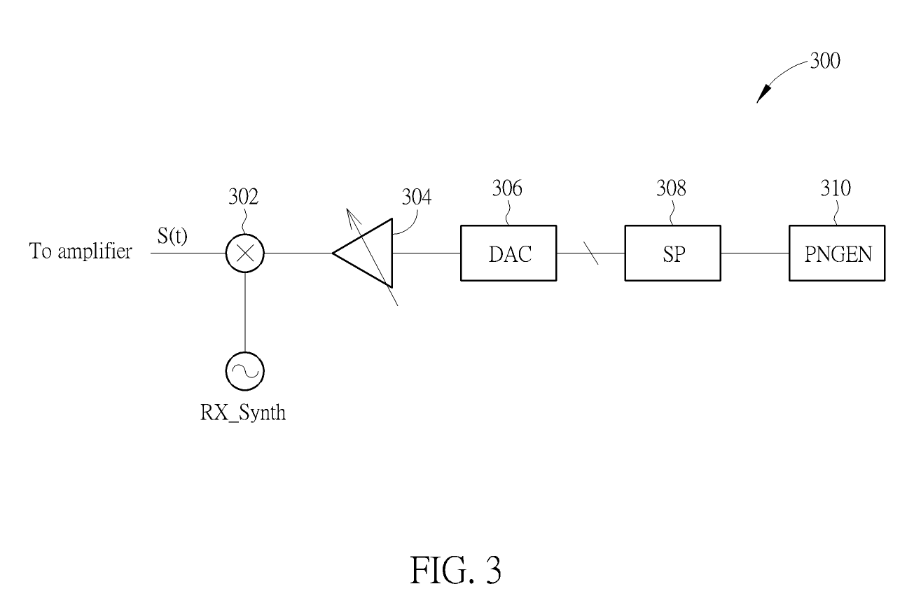

FIG. 3 is a diagram illustrating a training signal generator according to a first embodiment of the present invention. The training signal generator 204 shown in FIG. 2 may be implemented using the training signal generator 300 shown in FIG. 3. The training signal generator 300 has a mixer 302, a programmable gain amplifier (PGA) 304, a digital-to-analog converter (DAC) 306, a serial-to-parallel (SP) 308 and a pseudo noise sequence generator (PNGEN) 310 connected in series, where the local oscillator (LO) signal used by the mixer 302 is generated from a frequency synthesizer RX_Synth. Thus, the training signal S(t) in the RX band is generated and injected to a transmitter path. Specifically, the PNGEN 310 is arranged to generate a pseudo noise (PN) sequence as training data, and the training signal S(t) is generated based on the PN sequence. The PGA 304 tracks the main path gain, for example, by using a correlation technique, and adaptively adjusts the power level of the training signal S(t) in the RX band to be lower than the Tx noise generated in the main path, say, 6 db below the main path. Besides, the power consumption of the training signal generator 300 is low. Preferably, the PN sequence generator 310 may be a 1-bit PN sequence generator (in this case the SP 308 is bypassed), which simplifies the hardware design of the training signal generator.

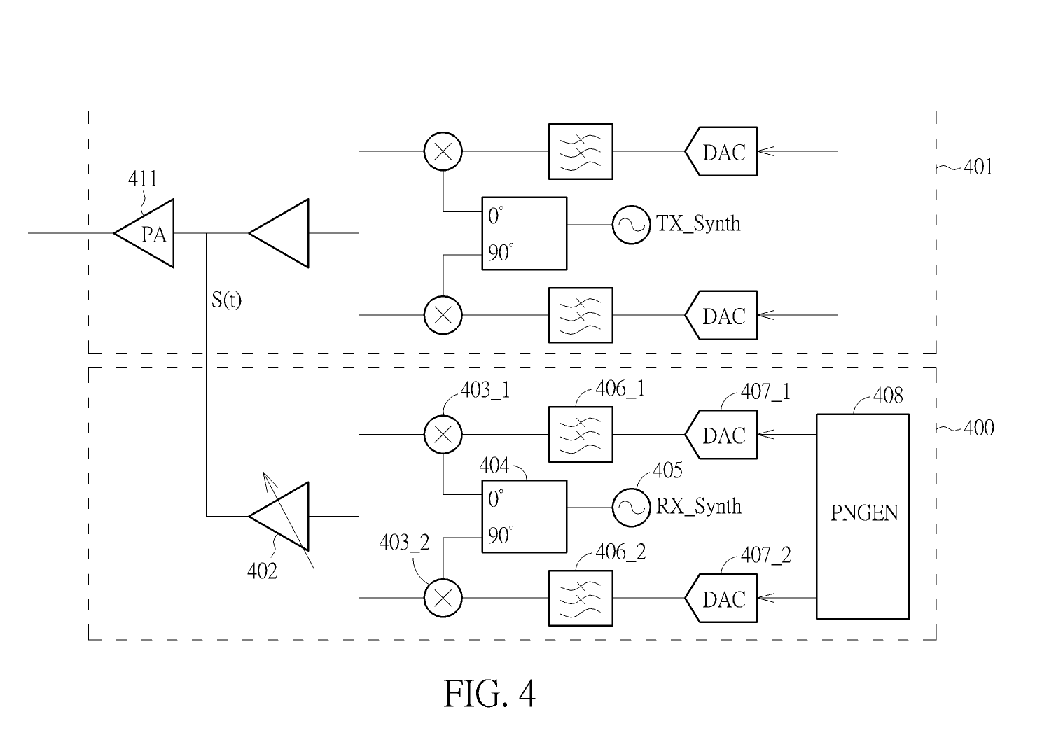

FIG. 4 is a diagram illustrating a training signal generator according to a second embodiment of the present invention. The training signal generator 204 shown in FIG. 2 may be implemented using the training signal generator 400 shown in FIG. 4. The training signal generator 400 has a PGA 402, mixers 403_1, 403_2, a divide-by-2 divider 404, a frequency synthesizer (RX_Synth) 405, filters 406_1, 406_2, DACs 407_1, 407_2, and a pseudo noise sequence generator (PNGEN) 408. The training signal S(t) is generated based on the PN sequence provided by the PNGEN 408. As shown in FIG. 4, the training signal S(t) in the RX band is injected to a transmitter path 401. Similarly, the PN sequence generator 408 may be realized by a 1-bit PN sequence generator to simplify the hardware design of the training signal generator. In this embodiment, the training signal generator 400 is attached to a node before the power amplifier (PA) 411 in the transmitter path 401. Alternatively, the training signal generator 400 may be attached to a node after the PA 411 in the transmitter path 401.

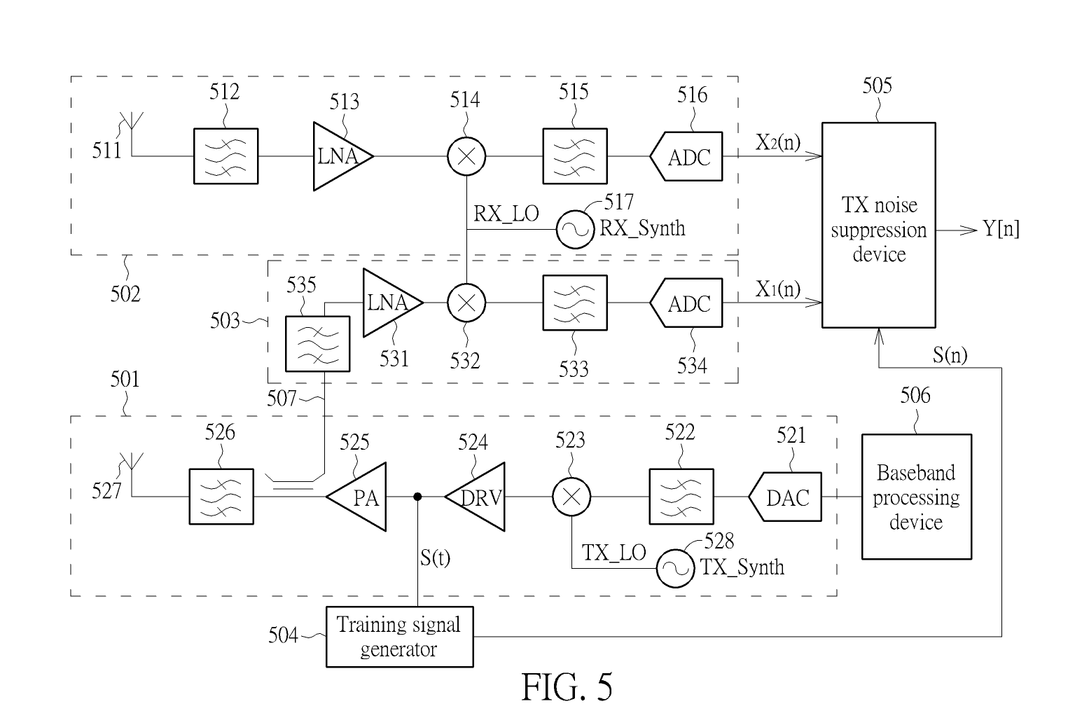

FIG. 5 is a diagram illustrating a portion of circuitry of a communication apparatus according to an embodiment of the present invention. By way of example, but not limitation, the receiver path 502 and the transmission noise suppression device 505 may be located in one radio module (e.g., radio module 110 of the communication apparatus 100), and the transmitter path 501, the training signal generator 504 and the baseband processing device 506 may be located in another radio module (e.g., radio module 120 of the communication apparatus 100). In the transmitter path 501, a DAC 521, a filter 522, a mixer 523, a PA driver amplifier (DRV) 524, a PA 525, a filter 526, and an antenna 527 are connected in series, where an LO signal TX_LO received by the mixer 523 is generated from a frequency synthesizer (TX_Synth) 528. In this example, the training signal S(t) in the RX band is generated from the training signal generator 504 and injected to a node between PA 525 and PA driver amplifier 524. In the receiver path 502 which is a main path of the transmission noise suppression device 505, an antenna 511, a filter 512, an LNA 513, a mixer 514, a filter 515, and an analog-to-digital converter (ADC) 516 are connected in series, where an LO signal RX_LO received by the mixer 514 is generated from a frequency synthesizer (RX_Synth) 517. As shown in FIG. 5, there is a coupling path (i.e., a loopback path) 507 between the transmitter path 501 and a reference path 503 of the transmission noise suppression device 505. Specifically, an input signal of the reference path 503 is a loopback signal derived from an output signal of the PA 525. In the reference path 503, a filter 535, an LNA 531, a mixer 532, a filter 533 and an ADC 534 are connected in series, where the mixer 532 also receives the same LO signal RX_LO generated from the frequency synthesizer (RX_Synth) 517. Preferably, the training signal S(t) is also generated based on the same LO signal RX_LO, as illustrated in the examples shown in FIG. 3 and FIG. 4. Hence, the training signal S(t) in the RX band is injected to the transmitter path 501, and then coupled to the reference path 503 through loopback.

The reference path 503 outputs a reference signal X₁ (n) (which is a digital signal) to the transmission noise suppression device 505. The main path (i.e., the receiver path 502) outputs a received signal X₂(n) (which is a digital signal) to the transmission noise suppression device 505. The transmission noise suppression device 505 further receives training data S(n) from the training signal generator 504. For example, the training data S(n) may be the PN sequence generated from the PNGEN 310/408 shown in FIG. 3/FIG. 4. Hence, the transmission noise suppression device 505 operates in a digital domain to generate a processed signal Y(n) with transmission noise suppressed/cancelled. Further details of the training-based transmission noise suppression are described as below.

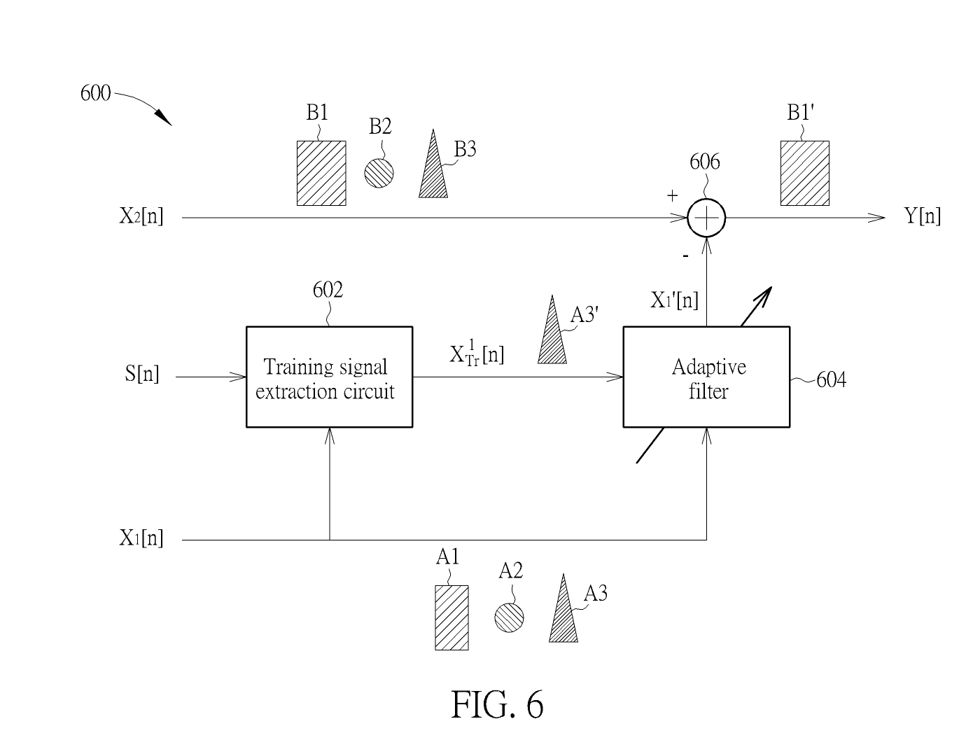

Please refer to FIG. 6, which is a diagram illustrating a transmission noise suppression device according to a first embodiment of the present invention. The transmission noise suppression device 505 shown in FIG. 5 may be implemented using the exemplary transmission noise suppression device 600 shown in FIG. 6. In this embodiment, the transmission noise suppression device 600 employs training-based single-path transmission noise suppression/cancellation architecture. As shown in FIG. 6, the transmission noise suppression device 600 has a training signal extraction circuit 602, an adaptive filter 604 and a subtractor (i.e., an adder which performs data subtraction) 606. The reference signal X₁[n] contains a leaked receiving signal part A1 indicated by a rectangular, a transmission noise part A2 indicated by a circle, and a training signal part A3 indicated by a triangle. Due to the interference between the receiver path and the transmitter path, the received signal X₂[n] includes a desired receiving signal part B1 indicated by a rectangular, a transmission noise part B2 indicated by a circle, and a training signal part B3 indicated by a triangle. The training signal extraction circuit 602 is arranged to receive the training data S[n] and the reference signal X₁[n], and obtains an extracted training signal X_{Tr}¹[n] (labeled as A3′) from the reference signal X₁[n] according to the training data S[n]. For example, the training signal extraction circuit 602 performs channel estimation based on the correlation between the training data S[n] and its corresponding part A3 in the reference signal X₁[n]. Hence, X_{Tr}¹[n]=\vec{G}′·\vec{S}[n], where \vec{G} is the channel estimation result of certain length, e.g., L, and \vec{S}[n] is a vector containing L elements of the training signal from time n−L+1 to n

The adaptive filter 604 is arranged for adaptively setting filter parameters thereof according to the extracted training signal X_{Tr}¹[n] and the received signal X₂[n], and filtering the reference signal X₁[n] to generate a filtered signal X_{1′}[n]. The subtractor 606 is arranged for subtracting the filtered signal X_{1′}[n] from the received signal X₂[n] to obtain the processed signal Y[n] (labeled as B1′). Training signal extraction and adaptive filtering basically are the same in principle, and the difference therebetween is the output. For example, the adaptive filter 604 performs channel estimation based on the extracted training signal X_{Tr}¹[n] and the received X₂[n] such that Tx_{Noise}²=Tx_{Noise}¹*\vec{g}, where \vec{g} is the channel estimation result and * represents the convolution operation, Tx_{Noise}² is the transmission noise part B2 comprised in the received signal X₂[n], and Tx_{Noise}¹ is the transmission noise part A2 comprised in the reference signal X₁[n]. The filter parameters (gₖ, k=0, 1 . . . L−1, where L is an order of the adaptive filter 604) are set based on the channel estimation result \vec{g}. The training signal sees a channel identical to the transmission noise. Hence, Tr²=Tr¹*\vec{g}, where Tr² is the training signal part B3 comprised in the received signal X₂[n], and Tr¹ is the training signal part A3 comprised in the reference signal X₁[n]. Notice the training signal A3 is approximated by the output A3′ of the training signal extraction circuit 602, and the actual channel estimation is based on the correlation between X2[n] and A3′. Further, since the training signal is independent of Tx noise as well as desired receiving signal, the effective correlation is between B3 and A3′. Y[n]=X₂[n]−\vec{g}*·\vec{X}₁[n], in which \vec{g} represents the channel response as a vector and \vec{X}₁[n] is a vector containing the same number of elements as the channel length of the reference signal up to time n. The processed signal Y[n] with transmission noise and training signal cancelled/suppressed is therefore obtained at an output of the subtractor 606. As the training signal extraction circuit 602 is able to create a “clean” reference input (i.e., X_{Tr}¹[n], labeled as A3′) for the adaptive filter 604, an accurate channel estimation result can be obtained, which enhances the performance of the transmission noise suppression/cancellation.

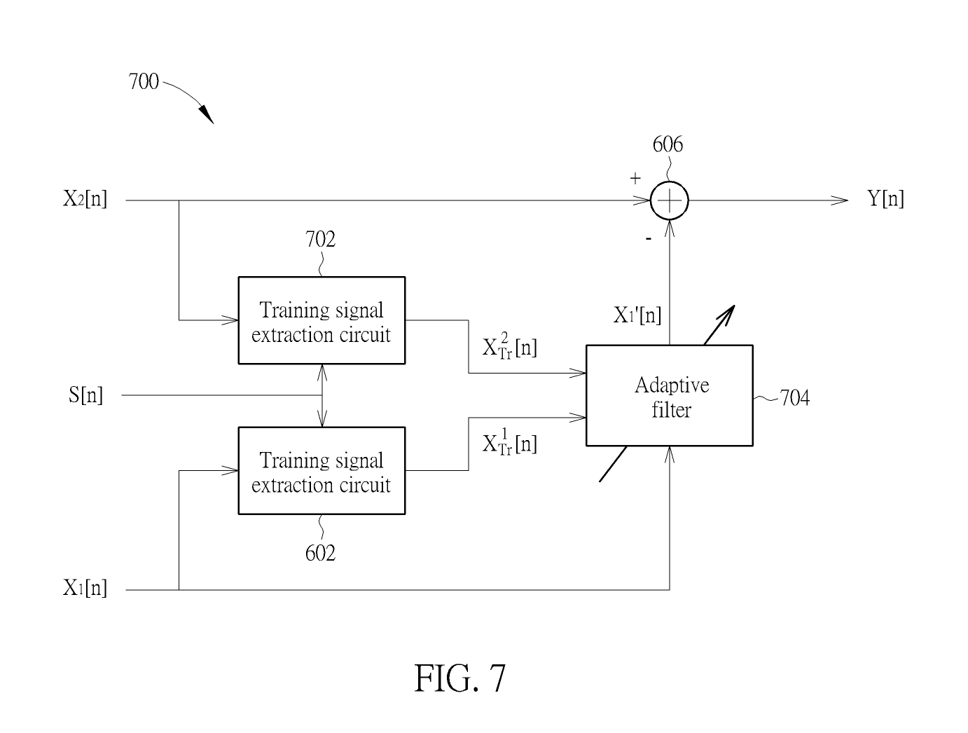

When the desired receiving signal part is relatively large compared to the training signal part and the transmission noise part, the training signal extraction stage would take longer processing time, resulting in a slower convergence speed. To achieve a faster convergence speed, the present invention therefore proposes using training-based dual-path transmission noise suppression/cancellation architecture. Please refer to FIG. 7, which is a diagram illustrating a transmission noise suppression device according to a second embodiment of the present invention. The transmission noise suppression device 505 may be implemented using the exemplary transmission noise suppression device 700 shown in FIG. 7. The transmission noise suppression device 700 includes two training signal extraction circuits 602, 702, an adaptive filter 704, and the subtractor (i.e., an adder which performs data subtraction) 606. Hence, the training signal extraction circuit 702 is arranged to receive the training data S[n] and the received signal X₂[n], and obtains another extracted training signal X_{Tr}²[n] from the received signal X₂[n] according to the training data S[n]. Similarly, the training signal extraction circuit 702 performs channel estimation based on the training data S[n] and the received signal X₂[n] such that X_{Tr}²[n]=\vec{H}*\vec{S}[n], where \vec{H} is the channel estimation result.

The adaptive filter 704 is arranged for adaptively setting filter parameters thereof according to both extracted training signals X_{Tr}¹[n], X_{Tr}²[n] and the received signal X₂[n], and filtering the reference signal X₁[n] to generate a filtered signal X_{1′}[n]. Similarly, the adaptive filter 704 performs channel estimation based on the extracted training signals X_{Tr}¹[n], X_{Tr}²[n] and the received X₂[n] such that Tx_{Noise}²=Tx_{Noise}¹*\vec{g}. The filter parameters (gₖ, k=0, 1 . . . L−1, where L is an order of the adaptive filter 704) are set based on the channel estimation result \vec{g}. As the channel estimation result \vec{g} is determined based on two extracted training signals X_{Tr}¹[n] and X_{Tr}²[n], a faster convergence speed is achieved because of this symmetric two stage arrangement. The subtractor 606 is arranged for subtracting the filtered signal X_{1′}[n] from the received signal X₂[n] to obtain the processed signal Y[n].

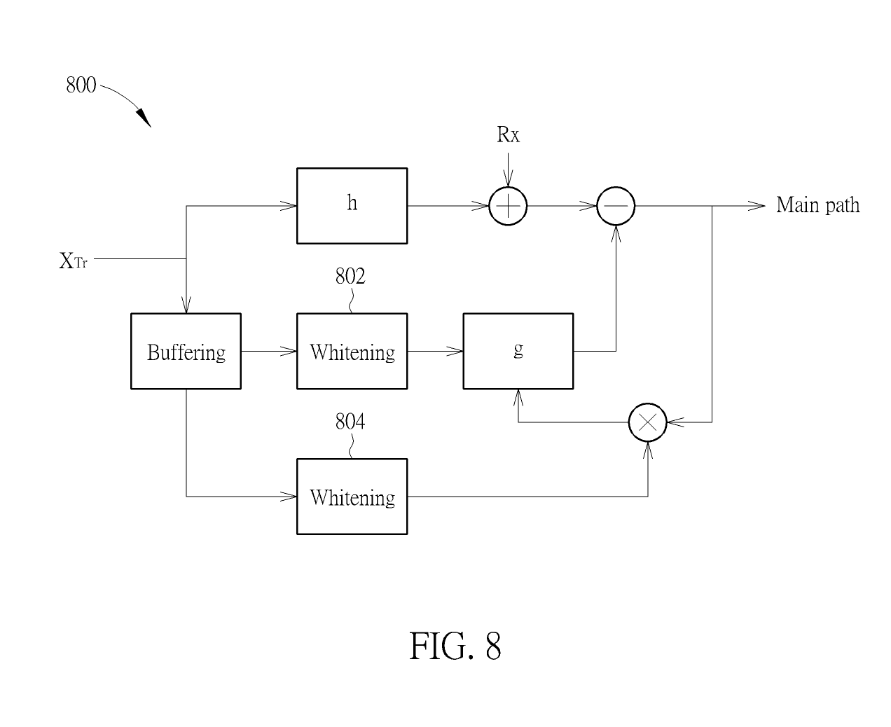

In some embodiments of the present invention, the transmission noise suppression device may further include at least one decorrelator implemented in the adaptive filter to make the extracted training signal decorrelated for speeding up convergence. FIG. 8 is a diagram illustrating a first speed-up strategy according to an embodiment of the present invention. In this embodiment, the transmission noise suppression device 800 has whitening operators 802, 804 implemented therein. In FIG. 8, X_{Tr} represents the extracted training signal, h represents the channel to be estimated, and R_{X} represents the receiving signal. The combination of whitening (whitening operator 802) and g is an estimation of the channel h. Hence, the extracted training signal X_{Tr} is de-correlated by using the whitening filters. For example, the extracted training signal X_{Tr} is colored, and the coloring matrix is P. The whitening algorithm applied to the covariance matrix Rx=PP* would make D^{-0.5}V*PP*VD^{0.5}=I, where D and V represent eigen-value matrix and eigen-vector matrix of the covariance matrix of the training signal.

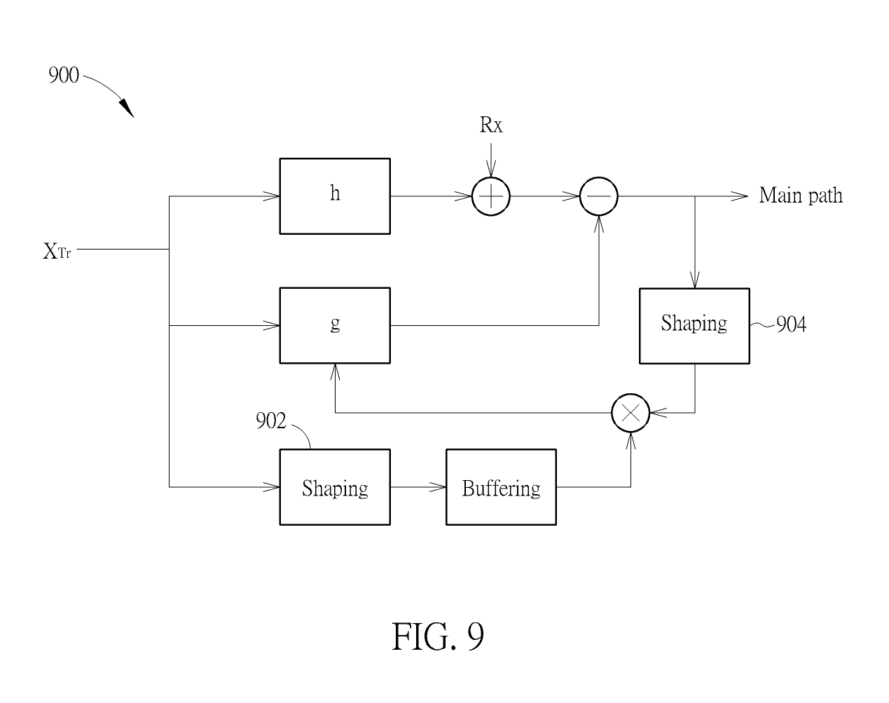

The whitening filter performs complicated matrix operation, and the associated hardware cost is high. Compared to the whitening algorithm, the shaping algorithm is easy to implement. FIG. 9 is a diagram illustrating a second speed-up strategy according to an embodiment of the present invention. In this embodiment, the transmission noise suppression device 900 has shaping filters 902, 904 implemented therein, where g is an estimation of the channel h. The correlated extracted training signal spreads the eigen-values. The shaping filter F is therefore used to decorrelate the training signal to make the covariance matrix more diagonal. For example, the shaping algorithm applied to the covariance matrix Rx=PP* would make FPP*F*≈I. The shaping is an approximation of whitening. If we put a shaping filter into a matrix, it is a Toeplitz matrix with each row filled with a shifted copy of the shaping filter. The quality difference between shaping and whitening depends on how well the Toeplitz matrix can serve as an eigen-vector matrix.

The transmission noise suppression device may employ one of two operating strategies, including strategy I and strategy II. When the strategy I is employed, a large step size is used in the extraction stage, and a small step size is used in the suppression/cancellation stage. The large step size in the extraction stage leads to fast convergence in the extraction but large extraction error. The suppression/cancellation stage further reduces the extraction error, where an equivalent step size of the transmission noise suppression device is equal to a product of step sizes in the extraction stage and the suppression/cancellation stage. When the strategy II is employed, a small step size is used in the extraction stage, and a large step size is used in the suppression/cancellation stage. The extraction stage using a small step size means it might not reach a steady state in a given time. However, the strategy II works better than strategy I in at least two respects. The adaptive filter performance is better, and a simple operation is allowed in the suppression/cancellation stage.

For the transmission noise suppression device 600 employing the training-based single-path transmission noise suppression/cancellation architecture, only the strategy I is applicable, because if strategy II is used, the large step size of the cancellation stage leads to poor adaptive filter performance when large desired receiving signal is present. Hence, the training signal extraction circuit 602 is configured to employ a first step size, the adaptive filter 604 is configured to employ a second step size, and the first step size is larger than the second step size. Besides, the transmission noise suppression device 600 is preferably used for a low RX signal level and power saving.

With regard to the transmission noise suppression device 700 employing the training-based dual-path transmission noise suppression/cancellation architecture, the main benefits include improved speed for handling a large RX signal, improved performance for a given time limit, and short taps allowed in the suppression/cancellation stage. The transmission noise suppression device 700 may use either strategy I or strategy II. Preferably, the transmission noise suppression device 700 is configured to use strategy II. Hence, the training signal extraction circuit 602 is configured to employ a first step size, the training signal extraction circuit 702 is configured to employ a second step size, the adaptive filter 704 is configured to employ a third step size, and the third step size is larger than each of the first step size and the second step size.

Compared to the training-based dual-path transmission noise suppression/cancellation mode, the training-based single-path transmission noise suppression/cancellation mode is more suitable for processing an RX signal in the main path that has a lower RX signal level. However, compared to the training-based single-path transmission noise suppression/cancellation mode, the training-based dual-path transmission noise suppression/cancellation mode is more suitable for processing an RX signal in the main path that has a higher RX signal level. To achieve optimized transmission noise suppression/cancellation performance, an adaptive mode switching scheme may be used.

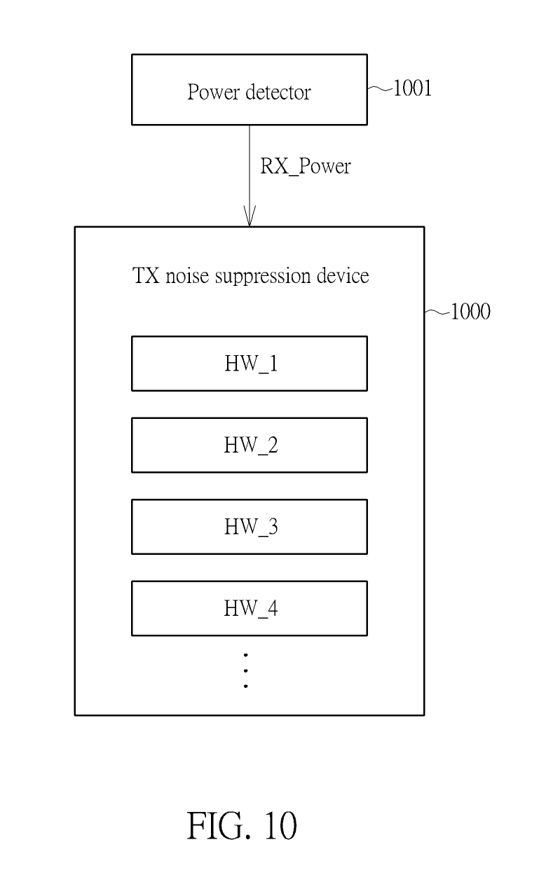

Please refer to FIG. 10, which is a diagram illustrating a transmission noise suppression device according to a third embodiment of the present invention. The transmission noise suppression device 505 shown in FIG. 5 may be implemented using the exemplary transmission noise suppression device 1000 shown in FIG. 10. The transmission noise suppression device 1000 is coupled to a power detector 1001, and has a plurality of different arrangements of hardware elements (e.g., HW_{—}1, HW_{—}2, HW_{—}3, HW_{—}4) corresponding to different transmission noise suppression configurations, respectively. By way of example, but not limitation, when the arrangement of hardware elements HW_{—}1 is enabled, a traditional adaptive noise canceller (ANC) is enabled; when the arrangement of hardware elements HW_{—}2 is enabled, the proposed training-based single-path noise suppression/cancellation architecture is enabled; when the arrangement of hardware elements HW_{—}3 is enabled, the proposed training-based dual-path noise suppression/cancellation architecture is enabled; and when the arrangement of hardware elements HW_{—}4 is enabled, no transmission noise suppression/cancellation is enabled (i.e., the transmission noise suppression/cancellation function is turned off). The power detector 1001 is arranged to estimate a receiver input power level RX_Power. As the receiver input power level RX_Power is time-variant, the transmission noise suppression device 1000 may dynamically switch between different transmission noise suppression configurations according to the receiver input power level RX_Power.

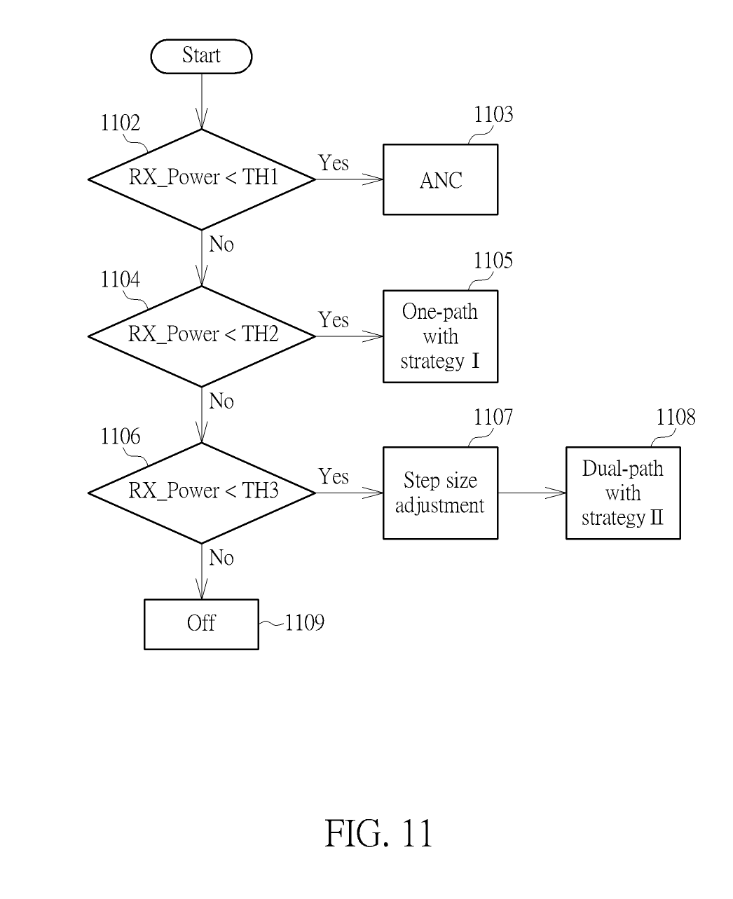

Please refer to FIG. 10 in conjunction with FIG. 11. FIG. 11 is a flowchart illustrating the adaptive mode switching scheme employed by the transmission noise suppression device 1000 according to an embodiment of the present invention. If the result is substantially the same, the steps are not required to be executed in the exact order shown in FIG. 11. In step 1102, the receiver input power level (RX_Power) is compared with a first threshold TH1 (e.g., TH1=−80 dBm). When RX_Power<TH1, the transmission noise suppression device 1000 selects the arrangement of hardware elements HW_{—}1, such that the traditional adaptive noise canceller (ANC) is enabled (step 1103). Specifically, a small receiver input power level means the leakage of desired receiving signal to the reference path is small and the cross-talk problem is not present. When RX_Power≧TH1, the flow proceeds with step 1104. Hence, the receiver input power level RX_Power is compared with a second threshold TH2 (e.g., TH2=−70 dBm). When TH1≦RX_Power<TH2, the transmission noise suppression device 1000 selects the arrangement of hardware elements HW_{—}2, such that the proposed training-based single-path noise suppression/cancellation architecture with strategy I is enabled (step 1105). Specifically, for certain extraction quality, the single-path mode provides a better channel estimation quality compared to the dual-path mode. When RX_Power≧TH2, the flow proceeds with step 1106. Hence, the receiver input power level RX_Power is compared with a third threshold TH3 (e.g., TH3=−40 dBm). When TH2≦RX_Power<TH3, the transmission noise suppression device 1000 selects the arrangement of hardware elements HW_{—}3, such that the proposed training-based dual-path noise suppression/cancellation architecture with strategy II is enabled (step 1108). Specifically, the dual-mode converges faster in a case of a large receiver input power than the one-path mode. Besides, an optional step size adjustment can be performed (step 1107). The step size μ may be adjusted based on the following equation:

$$μ \approx \frac{2 \cdot EMSE}{Tr ( R ) \cdot {σ}_{rx}^{2}} ,$$

where EMSE represents an estimated mean square error, Tr represents trace, R is the covariance matrix of the extracted training signal, and σ²_{Rx} is power of the received signal. When RX_Power≧TH3, the transmission noise suppression device 1000 selects the arrangement of hardware elements HW_{—}4, such that the transmission noise suppression/cancellation function is turned off. It should be noted that the aforementioned threshold values can be adjusted for different applications.

In above embodiments, each of the transmission noise suppression devices 600 and 700 applies transmission noise suppression to a single receiver path (i.e., a single main path). In alternative designs of the present invention, the proposed training-based noise suppression scheme may be easily extended to a multi-main-path receiver case.

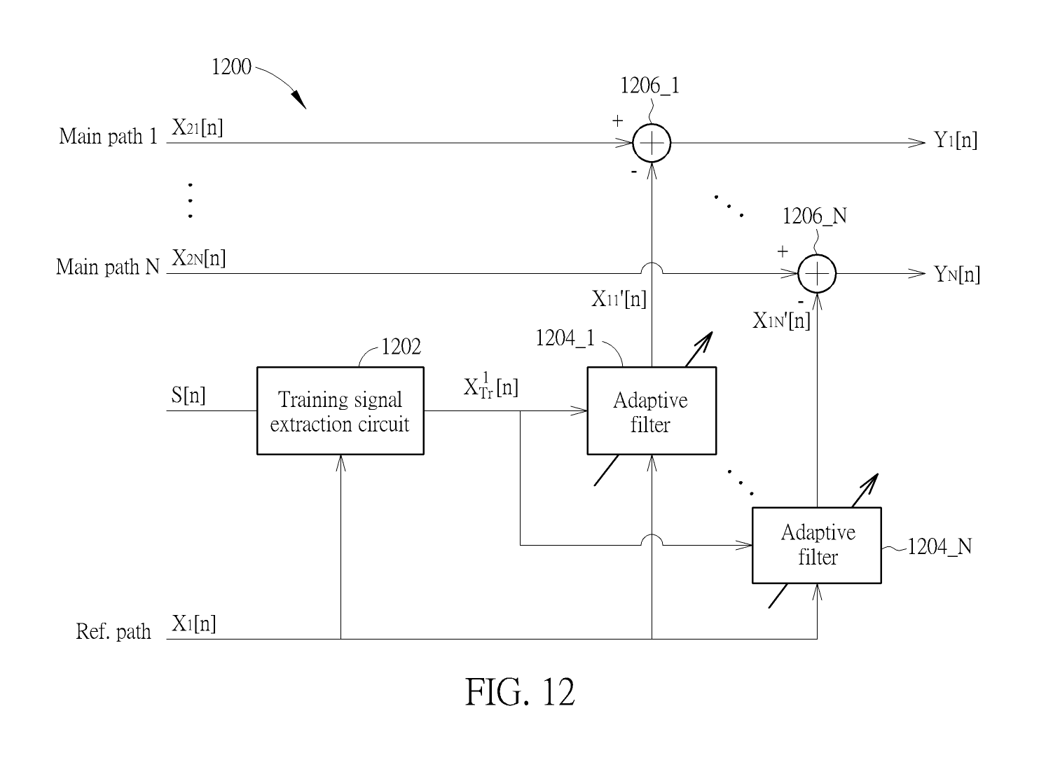

FIG. 12 is a diagram illustrating a transmission noise suppression device according to a fourth embodiment of the present invention. In this embodiment, the communications apparatus has N receiver paths which are main paths for the transmission noise suppression device 1200. Hence, the transmission noise suppression device 1200 receives N received signals X₂₁[n]-X_{2N}[n] from the N main paths, respectively. The transmission noise suppression device 1200 employs the aforementioned training-based single-path noise suppression/cancellation architecture to apply noise suppression/cancellation to each of the received signals X₂₁[n]-X_{2N}[n]. As shown in FIG. 12, the transmission noise suppression device 1200 includes a training signal extraction circuit 1202, a plurality of adaptive filters 1204_1-1204_N, and a plurality of subtractors 1206_1-1206_N. The operation of the training signal extraction circuit 1202 is identical to that of the training signal extraction circuit 602. Hence, an extracted training signal X_{Tr}¹[n] is extracted from the reference signal X₁[n] according to the training data S[n]. The operation of each of the adaptive filters 1204_1-1204_N is identical to that of the adaptive filter 604. It should be noted that the same extracted training signal X_{Tr}¹[n] and reference signal X₁[n] are provided to all of the adaptive filters 1204_1-1204_N. Hence, the adaptive filter 1204_1 adaptively sets its filter parameters according to the extracted training signal X_{Tr}¹[n] and the received signal X₂₁[n], and filters the reference signal X₁[n] to generate a filtered signal X_{11′}[n]. The adaptive filter 1204_N adaptively sets its filter parameters according to the extracted training signal X_{Tr}¹[n] and the received signal X_{2N}[n], and filters the reference signal X₁[n] to generate a filtered signal X_{1N′}[n]. Next, the subtractor 1206_1 subtracts the filtered signal X_{11′}[n] from the received signal X₂₁[n] to generate a processed signal Y₁[n]; and the subtractor 1206_N subtracts the filtered signal X_{1N′}[n] from the received signal X_{2N}[n] to generate a processed signal Y_{N}[n]. To put it simply, when there are N receiver paths, the transmission noise suppression device 1200 is configured to have one extraction stage and N suppression/cancellation stages.

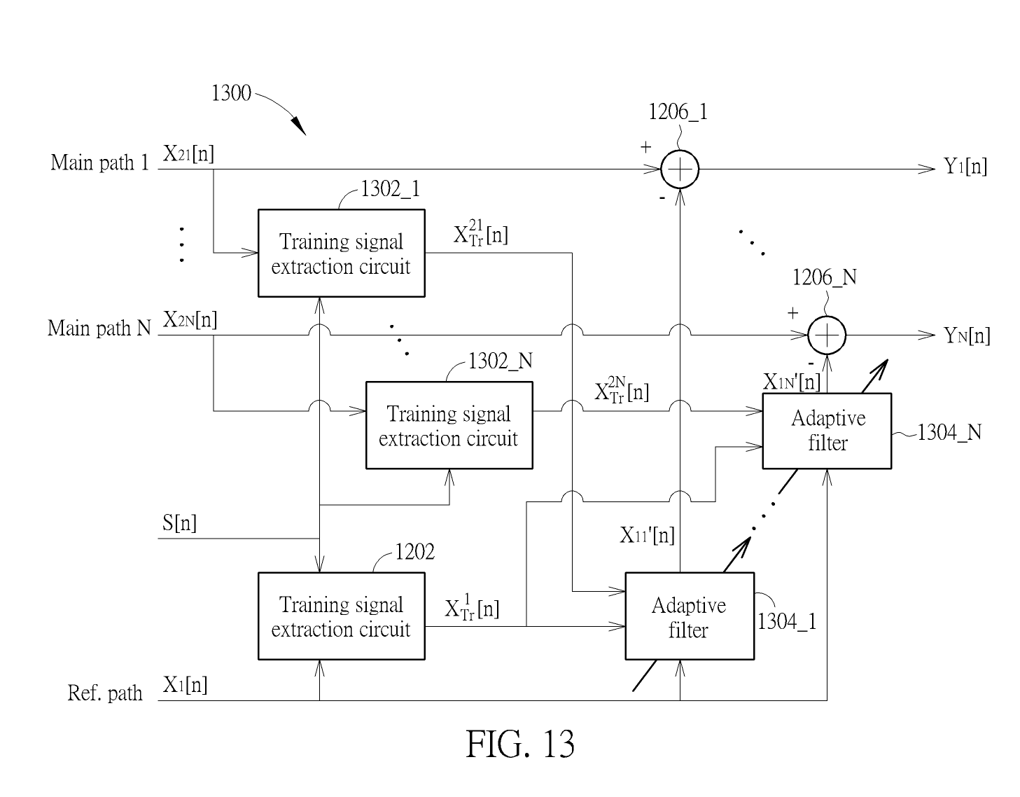

FIG. 13 is a diagram illustrating a transmission noise suppression device according to a fifth embodiment of the present invention. In this embodiment, the communication apparatus has N receiver paths which are main paths for the transmission noise suppression device 1300. Hence, the transmission noise suppression device 1300 receives N received signals X₂₁[n]-X_{2N}[n] from the N main paths, respectively. The transmission noise suppression device 1300 employs the aforementioned training-based dual-path noise suppression/cancellation architecture to apply noise suppression/cancellation to each of the received signals X₂₁[n]-X_{2N}[n]. As shown in FIG. 13, the transmission noise suppression device 1300 includes a plurality of training signal extraction circuits 1202, 1302_1-1302_N, a plurality of adaptive filters 1304_1-1304_N, and a plurality of subtractors 1206_1-1206_N. The operation of the training signal extraction circuit 1202 is identical to that of the training signal extraction circuit 602. Hence, an extracted training signal X_{Tr}¹[n] is extracted from the reference signal X₁[n] according to the training data S[n]. Besides, the operation of each of the training signal extraction circuits 1302_1-1302_N is identical to that of the training signal extraction circuit 702. Hence, an extracted training signal X_{Tr}²¹[n] is extracted from the received signal X₂₁[n] according to the training data S[n], and an extracted training signal X_{Tr}^{2N}[n] is extracted from the received signal X_{2N}[n] according to the training data S[n]. The operation of each of the adaptive filters 1304_1-1304_N is identical to that of the adaptive filter 704. It should be noted that the same extracted training signal X_{Tr}^{1r}[n] and reference signal X₁[n] are provided to all of the adaptive filters 1304_1-1304_N. Hence, the adaptive filter 1304_1 adaptively sets its filter parameters according to two extracted training signals X_{Tr}¹[n], X_{Tr}²¹[n] and the received signal X₂₁[n], and filters the reference signal X₁[n] to generate a filtered signal X_{11′}[n]. The adaptive filter 1304_N adaptively sets its filter parameters according to two extracted training signals X_{Tr}¹[n], X_{Tr}^{2N}[n] and the received signal X_{2N}[n], and filters the reference signal X₁[n] to generate a filtered signal X_{1N′}[n]. Next, the subtractor 1206_1 subtracts the filtered signal X_{11′}[n] from the received signal X₂₁[n] to generate a processed signal Y₁[n]; and the subtractor 1206_N subtracts the filtered signal X_{1N′}[n] from the received signal X_{2N}[n] to generate a processed signal Y_{N}[n]. To put it simply, when there are N receiver paths, the transmission noise suppression device 1300 is configured to have (N+1) extraction stage and N suppression/cancellation stages.

It should be noted that the aforementioned transmission noise suppression devices 600, 700, 1000, 1200,1300 are for illustrative purposes only, and are not meant to be limitations of the present invention. That is, modifying these exemplary transmission noise suppression devices without departing from the spirit of the present invention is feasible. To put it another way, any communications apparatus employing the proposed training-based transmission noise suppression/cancellation concept falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communications apparatus, comprising:
a transmitter path, arranged for transmitting a transmission signal; and
a training signal generator, arranged for generating a training signal in a receiver band, and injecting the training signal to the transmitter path;
wherein the training signal is referenced to suppress transmission noise comprised in at least one received signal of the communications apparatus, and the transmission noise is generated by the transmitter path.

2. The communications apparatus of claim 1, wherein the training signal generator includes a pseudo noise (PN) sequence generator arranged to generate a PN sequence, where the training signal is generated based on the PN sequence.

3. The communications apparatus of claim 2, wherein the PN sequence generator is a 1-bit PN sequence generator.

4. The communications apparatus of claim 1, further comprising:
a first receiver path, arranged for receiving a first received signal; and
a transmission noise suppression device, arranged for receiving training data of the training signal, and processing the first received signal to suppress transmission noise comprised in the first received signal according to at least the training data.

5. The communications apparatus of claim 4, wherein the transmission noise suppression device comprises:
a training signal extraction circuit, arranged for receiving the training data and a reference signal derived from the transmission signal, and obtaining an extracted training signal from the reference signal according to the training data;
a first adaptive filter, arranged for adaptively setting filter parameters thereof according to the extracted training signal and the first received signal, and filtering the reference signal to generate a first filtered signal; and
a first subtractor, arranged for subtracting the first filtered signal from the first received signal to obtain a first processed signal.

6. The communications apparatus of claim 5, wherein the transmission noise suppression device further comprises at least one decorrelator to make the extracted training signal decorrelated for speeding up convergence.

7. The communications apparatus of claim 6, wherein the at least one decorrelator includes a whitening operator or a shaping filter.

8. The communications apparatus of claim 5, wherein the training signal extraction circuit is configured to employ a first step size, the first adaptive filter is configured to employ a second step size, and the first step size is larger than the second step size.

9. The communications apparatus of claim 5, wherein the communications apparatus further comprises a second receiver path arranged for receiving a second received signal; and the transmission noise suppression device further comprises:
a second adaptive filter, arranged for adaptively setting filter parameters thereof according to the extracted training signal and the second received signal, and filtering the reference signal to generate a second filtered signal; and
a second subtractor, arranged for subtracting the second filtered signal from the second received signal to obtain a second processed signal.

10. The communications apparatus of claim 4, wherein the transmission noise suppression device comprises:
a first training signal extraction circuit, arranged for receiving the training data and the first received signal, and obtaining a first extracted training signal from the first received signal according to the training data;
a second training signal extraction circuit, arranged for receiving the training data and a reference signal derived from the transmission signal, and obtaining a second extracted training signal from the reference signal according to the training data;
a first adaptive filter, arranged for setting filter parameters thereof according to the first extracted training signal, the second extracted training signal and the first received signal, and filtering the reference signal to generate a first filtered signal; and
a first subtractor, arranged for subtracting the first filtered signal from the first received signal to obtain a first processed signal.

11. The communications apparatus of claim 10, wherein the transmission noise suppression device further comprises at least one decorrelator to make the extracted training signal decorrelated for speeding up convergence.

12. The communications apparatus of claim 11, wherein the at least one decorrelator includes a whitening operator or a shaping filter.

13. The communications apparatus of claim 10, wherein the first training signal extraction circuit is configured to employ a first step size, the second training signal extraction circuit is configured to employ a second step size, the first adaptive filter is configured to employ a third step size, and the third step size is larger than each of the first step size and the second step size.

14. The communications apparatus of claim 4, wherein the communications apparatus further comprises a second receiver path arranged for receiving a second received signal; and the transmission noise suppression device further comprises:
a third training signal extraction circuit, arranged for receiving the training data and the second received signal, and obtaining a third extracted training signal from the second received signal according to the training data;
a second adaptive filter, arranged for setting filter parameters thereof according to the third extracted training signal, the second extracted training signal and the second received signal, and filtering the reference signal to generate a second filtered signal; and
a second subtractor, arranged for subtracting the second filtered signal from the second received signal to obtain a second processed signal.

15. The communications apparatus of claim 4, wherein the transmission noise suppression device supports a plurality of transmission noise suppression configurations, and employs one of the transmission noise suppression configurations according to a receiver input power level.

16. The communications apparatus of claim 1, wherein the training signal generator continuously injects the training signal to the transmitter path when the communications apparatus operates under a discontinuous transmission (DTX) mode.

17. A method applied in a communications apparatus, comprising:
transmitting a transmission signal via a transmitter path;
generating a training signal in a receiver band; and
injecting the training signal to the transmitter path;
wherein the training signal is referenced to suppress transmission noise comprised in at least one received signal of the communications apparatus, and the transmission noise is generated by the transmitter path.

18. The method of claim 17, wherein the step of generating the training signal comprises:
generating a pseudo noise (PN) sequence; and
generating the training signal according to the PN sequence.

19. The method of claim 18, wherein the PN sequence is a 1-bit PN sequence.

20. The method of claim 17, further comprising:
receiving a first received signal via a first receiver path; and
performing transmission noise suppression by receiving training data of the training signal and processing the first received signal to suppress transmission noise comprised in the first received signal according to at least the training data.

21. The method of claim 20, wherein the step of performing the transmission noise suppression comprises:
receiving the training data and a reference signal derived from the transmission signal, and obtaining an extracted training signal from the reference signal according to the training data;
adaptively setting filter parameters of a first adaptive filtering operation according to the extracted training signal and the first received signal, and performing the first adaptive filtering operation upon the reference signal to generate a first filtered signal; and
subtracting the first filtered signal from the first received signal to obtain a first processed signal.

22. The method of claim 21, wherein the first adaptive filtering operation includes decorrelation for speeding up convergence of the first adaptive filtering operation.

23. The method of claim 22, wherein the decorrelation includes whitening or shaping.

24. The method of claim 21, wherein a first step size is employed for obtaining the extracted training signal from the reference signal according to the training data, the first adaptive filtering operation is configured to employ a second step size, and the first step size is larger than the second step size.

25. The method of claim 21, further comprising:
receiving a second received signal via a second receiver path;
wherein the step of performing the transmission noise suppression further comprises:
adaptively setting filter parameters of a second adaptive filtering operation according to the extracted training signal and the second received signal, and performing the second adaptive filtering operation upon the reference signal to generate a second filtered signal; and
subtracting the second filtered signal from the second received signal to obtain a second processed signal.

26. The method of claim 20, wherein the step of performing the transmission noise suppression comprises:
receiving the training data and the first received signal, and obtaining a first extracted training signal from the first received signal according to the training data;
receiving the training data and a reference signal derived from the transmission signal, and obtaining a second extracted training signal from the reference signal according to the training data;
setting filter parameters of a first adaptive filtering operation according to the first extracted training signal, the second extracted training signal and the first received signal, and performing the first adaptive filtering operation upon the reference signal to generate a first filtered signal; and
subtracting the first filtered signal from the first received signal to obtain a first processed signal.

27. The method of claim 26, wherein the first adaptive filtering operation includes decorrelation for speeding up convergence of the first adaptive filtering operation.

28. The method of claim 27, wherein the decorrelation includes whitening or shaping.

29. The method of claim 26, wherein a first step size is employed for obtaining the first extracted training signal from the first received signal according to the training data, a second step size is employed for obtaining the second extracted training signal from the reference signal according to the training signal, the first adaptive filter is configured to employ a third step size, and the third step size is larger than each of the first step size and the second step size.

30. The method of claim 20, further comprising:
receiving a second received signal via a second receiver path;
wherein the step of performing the transmission noise suppression comprises:
receiving the training data and the second received signal, and obtaining a third extracted training signal from the second received signal according to the training data;
setting filter parameters of a second adaptive filtering operation according to the third extracted training signal, the second extracted training signal and the second received signal, and performing the second adaptive filtering operation upon the reference signal to generate a second filtered signal; and
subtracting the second filtered signal from the second received signal to obtain a second processed signal.

31. The method of claim 20, wherein the transmission noise suppression supports a plurality of transmission noise suppression algorithms, and employs one of the transmission noise suppression algorithms according to a receiver input power level.

32. The method of claim 17, wherein the training signal is continuously injected to the transmitter path when the communications apparatus operates under a discontinuous transmission (DTX) mode.
